(19) United States
(12) Patent Application Publication
(10) Pub. No.: US 2025/0164841 A1
(43) Pub. Date: May 22, 2025

(54) LIQUID CRYSTAL OPTICAL ELEMENT

(71) Applicants: Japan Display Inc., Tokyo (JP); OSAKA UNIVERSITY, Osaka (JP)

(72) Inventors: Junji KOBASHI, Tokyo (JP); Shinichiro OKA, Tokyo (JP); Yoshinori TANAKA, Tokyo (JP); Hiroyuki YOSHIDA, Suita-shi (JP)

(73) Assignees: Japan Display Inc., Tokyo (JP); OSAKA UNIVERSITY, Osaka (JP)

(21) Appl. No.: 18/947,096

(22) Filed: Nov. 14, 2024

(30) Foreign Application Priority Data
Nov. 22, 2023 (JP) 2023-197865

(51) Int. Cl. G02F 1/1347; G02F 1/1335

(52) U.S. Cl. CPC G02F 1/13478; G02F 1/133541; G02F 1/133543; G02F 2201/343

(57) ABSTRACT

According to one embodiment, a liquid crystal optical element includes a transparent substrate, a liquid crystal layer provided above the transparent substrate, including a cholesteric liquid crystal, and configured to reflect first circularly polarized light having a same direction as a twist direction of the cholesteric liquid crystal, and a polarization control layer provided on the liquid crystal layer, and configured to control a polarization state of second circularly polarized light having a direction opposite to the first circularly polarized light, totally reflect the second circularly polarized light which passed through the liquid crystal layer and emit the light to the liquid crystal layer as the second circularly polarized light.

### CROSS-REFERENCE TO RELATED APPLICATIONS

This application is based upon and claims the benefit of priority from Japanese Patent Application No. 2023-197865, filed Nov. 22, 2023, the entire contents of which are incorporated herein by reference.

### FIELD

Embodiments described herein relate generally to a liquid crystal optical element.

### BACKGROUND

For example, a liquid crystal polarization grating using a liquid crystal material is suggested. In this liquid crystal polarization grating, to realize the desired optical performance, various parameters such as a grating period, the refractive anisotropy of a liquid crystal layer (the difference between refractive index ne for extraordinary light and refractive index no for ordinary light in a liquid crystal layer) and the thickness of the liquid crystal layer are adjusted.

In liquid crystal optical elements in which light is guided while repeating total reflection inside a transparent substrate, the prevention of a light guiding loss in which light leaks to the outside is required.

### BRIEF DESCRIPTION OF THE DRAWINGS

FIG. 1 is a cross-sectional view schematically showing a configuration example of a liquid crystal optical element 100.

FIG. 2 is a diagram for explaining an example of cholesteric liquid crystals CL contained in a liquid crystal layer 3.

FIG. 3 is a plan view schematically showing the alignment pattern of liquid crystal molecules in the liquid crystal layer 3.

FIG. 4 is a diagram for explaining an example of the polarization control layer 4 shown in FIG. 1.

FIG. 5 is a diagram for explaining the state in which light propagates in the liquid crystal optical element 100 shown in FIG. 1.

FIG. 6 is a diagram for explaining the state in which light propagates in the liquid crystal optical element 100 of a comparative example.

FIG. 7 is a diagram for explaining experimental conditions.

FIG. 8 is a diagram showing experimental results.

FIG. 9 is a cross-sectional view schematically showing another configuration example of the liquid crystal optical element 100.

FIG. 10 is a diagram for explaining an example of the polarization control layer 4 shown in FIG. 9.

FIG. 11 is a diagram for explaining the state in which light propagates in the liquid crystal optical element 100 shown in FIG. 9.

FIG. 12 is a cross-sectional view schematically showing another configuration example of the liquid crystal optical element 100.

FIG. 13 is a diagram for explaining the state in which light propagates in the liquid crystal optical element 100 shown in FIG. 12.

### DETAILED DESCRIPTION

Embodiments described herein aim to provide a liquid crystal optical element in which a light guiding loss can be prevented.

In general, according to one embodiment, a liquid crystal optical element comprises a transparent substrate, a liquid crystal layer provided above the transparent substrate, including a cholesteric liquid crystal, and configured to reflect first circularly polarized light having a same direction as a twist direction of the cholesteric liquid crystal, and a polarization control layer provided on the liquid crystal layer, and configured to control a polarization state of second circularly polarized light having a direction opposite to the first circularly polarized light, totally reflect the second circularly polarized light which passed through the liquid crystal layer and emit the light to the liquid crystal layer as the second circularly polarized light.

According to another embodiment, a liquid crystal optical element comprises a transparent substrate, a liquid crystal layer including a cholesteric liquid crystal, and configured to reflect first circularly polarized having a same direction as a twist direction of the cholesteric liquid crystal and transmit second circularly polarized light having a direction opposite to the first circularly polarized light, and a polarization control layer provided between the transparent substrate and the liquid crystal layer. The polarization control layer is configured to twice transmit the first circularly polarized light reflected on the liquid crystal layer and emit the light to the liquid crystal layer as the first circularly polarized light.

The embodiments can provide a liquid crystal optical element in which a light guiding loss can be prevented.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. The plane defined by the X-axis and the Y-axis is referred to as an X-Y plane. The plane defined by the X-axis and the Z-axis is referred to as an X-Z plane. The plane defined by the Y-axis and the Z-axis is referred to as a Y-Z plane. The X-axis and the Y-axis are parallel to a transparent substrate which constitute a liquid crystal optical element. The Z-axis corresponds to the thickness direction of the liquid crystal optical element.

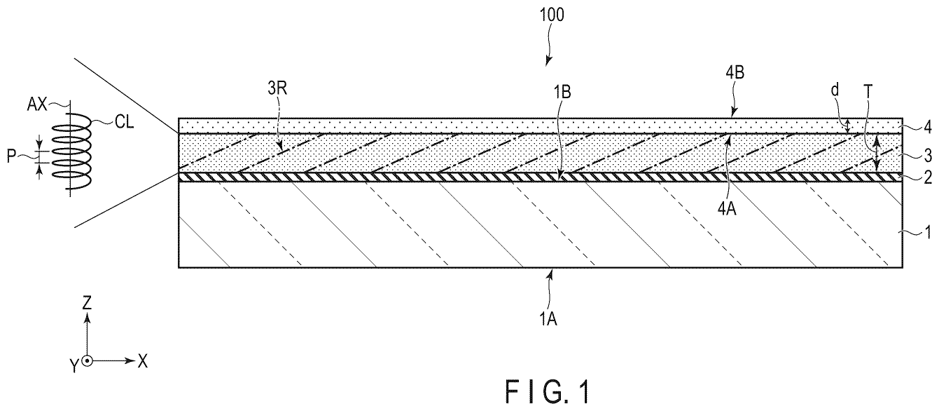

FIG. 1 is a cross-sectional view schematically showing a configuration example of a liquid crystal optical element 100.

The liquid crystal optical element 100 comprises a transparent substrate 1, an alignment control layer 2, a liquid crystal layer 3 and a polarization control layer 4.

The transparent substrate 1 consists of, for example, a transparent glass plate or a transparent synthetic resin plate. The transparent substrate 1 may consist of, for example, a transparent synthetic resin plate having flexibility. “The transparent substrate 1 could have an arbitrary shape. For example, the transparent substrate 1 may be curved.

In this specification, the term “light” includes visible light and invisible light. For example, the wavelength of the lower limit of the visible light range is greater than or equal to 350 nm and less than or equal to 400 nm. The wavelength of the upper limit of the visible light range is greater than or equal to 700 nm and less than or equal to 830 nm. Visible light includes a first component (blue component) of a first wavelength range (for example, 400 to 500 nm), a second component (green component) of a second wavelength range (for example, 500 to 600 nm), and a third component (red component) of a third wavelength range (for example, 600 to 700 nm). Invisible light includes ultraviolet light having a wavelength range in which the wavelength is shorter than the first wavelength range, and infrared light having a wavelength range in which the wavelength is longer than the third wavelength range.

In this specification, the term “transparent” should preferably mean “colorless and transparent”. However, the term “transparent” may mean “semitransparent” or “colored and transparent”.

The transparent substrate 1 is shaped like a flat plate parallel to an X-Y plane and has a main surface (outer surface) 1A and a main surface (inner surface) 1B. The main surface 1A and the main surface 1B are surfaces substantially parallel to an X-Y plane and face each other in a third direction Z.

The alignment control layer 2 is provided on the main surface 1B. The alignment control layer 2 may consist of a plurality of tiny protrusions or may be an optical alignment film to which alignment treatment is applied by light irradiation. It should be noted that the alignment control layer 2 may be omitted in the liquid crystal optical element 100.

The liquid crystal layer 3 is provided on the transparent substrate 1 or the alignment control layer 2 in the third direction Z. The liquid crystal layer 3 has a cholesteric liquid crystal CL which twists in a first twist direction as schematically shown in the enlarged view. The cholesteric liquid crystal CL has, for example, helical axis AX substantially parallel to the third direction Z and has helical pitch P parallel to the third direction Z. Helical pitch P indicates one period of the helix (in other words, the layer thickness parallel to helical axis AX and required for a 360-degree rotation of liquid crystal molecules).

The liquid crystal layer 3 has reflective surfaces 3R which incline with respect to the main surface 1B. The liquid crystal layer 3 is configured to reflect circularly polarized light having the same direction as the twist direction of the cholesteric liquid crystal CL on the reflective surfaces 3R and transmit circularly polarized light having a direction opposite to the twist direction. It should be noted that each reflective surface 3R reflects, of the incident light on the liquid crystal layer 3, circularly polarized light in a selective reflection range determined based on helical pitch P of the cholesteric liquid crystal CL and refractive anisotropy Δn of the liquid crystal layer 3. The selective reflection range may be a specific wavelength of visible light or may be invisible light such as ultraviolet light or infrared light.

For example, when the first twist direction is right-handed, right-handed circularly polarized light is reflected on the reflective surfaces 3R, and left-handed circularly polarized light passes through the liquid crystal layer 3. When the first twist direction is left-handed, left-handed circularly polarized light is reflected on the reflective surfaces 3R, and right-handed circularly polarized light passes through the liquid crystal layer 3. In this specification, reflection in the liquid crystal layer 3 is accompanied by diffraction inside the liquid crystal layer 3. In this specification, circularly polarized light may be strict circularly polarized light or may be circularly polarized light which approximates elliptically polarized light.

A liquid crystal layer which contains another cholesteric liquid crystal may be stacked in the liquid crystal layer 3 shown in FIG. 1 in the liquid crystal optical element 100. Such a cholesteric liquid crystal is, for example, a cholesteric liquid crystal having a helical pitch which is different from helical pitch P shown in the figure or a cholesteric liquid crystal which twists in a second twist direction opposite to the first twist direction.

The liquid crystal layer 3 has thickness T parallel to the third direction Z. Thickness T is set based on the selective reflection range in the liquid crystal layer 3 and the like.

The polarization control layer 4 is a thin film having uniaxial anisotropy and is configured to control the polarization state of transmitted light. The polarization control layer 4 is provided on the liquid crystal layer 3, and for example, is attached to the liquid crystal layer 3. The polarization control layer 4 has a first surface 4A which faces the liquid crystal layer 3 in the third direction Z, and a second surface 4B on a side opposite to the first surface 4A. The first surface 4A and the second surface 4B face each other in the third direction Z. The second surface 4B is in contact with a low-refractive layer having a refractive index which is lower than that of the polarization control layer 4. In the example shown in the figure, the second surface 4B is in contact with an air layer as the low-refractive layer.

The polarization control layer 4 has thickness d parallel to the third direction Z. Thickness d is equal to thickness T of the liquid crystal layer 3 or less than thickness T.

The polarization control layer 4 is configured to totally reflect left-handed circularly polarized light which passed through the reflective surface 3R of the liquid crystal layer 3 and emit the light to the liquid crystal layer 3 as left-handed circularly polarized light, or totally reflect right-handed circularly polarized light which passed through the reflective surface 3R of the liquid crystal layer 3 and emit the light to the liquid crystal layer 3 as right-handed circularly polarized light. The details of the polarization control layer 4 are described later.

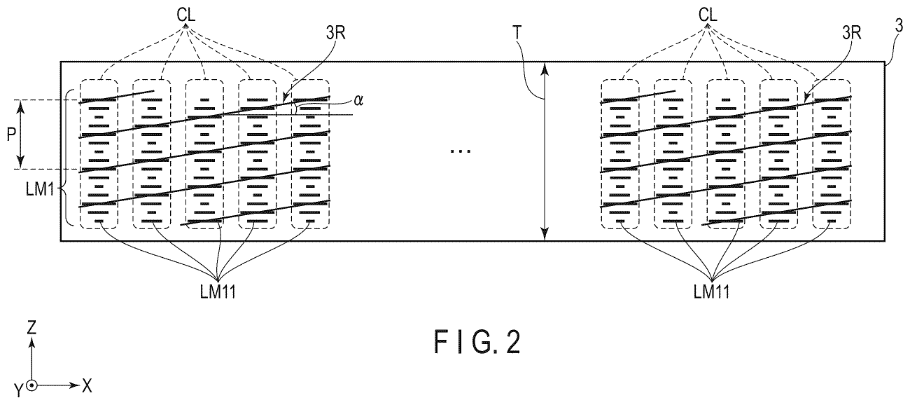

FIG. 2 is a diagram for explaining an example of cholesteric liquid crystals CL contained in the liquid crystal layer 3.

In FIG. 2, the liquid crystal layer 3 is enlarged in the third direction Z. In addition, to simplify the illustration, FIG. 2 shows one liquid crystal molecule LM1 among the liquid crystal molecules located in the same plane parallel to an X-Y plane as the liquid crystal molecules LM1 constituting each cholesteric liquid crystal CL. The alignment direction of each liquid crystal molecule LM1 shown in the figure corresponds to the average alignment direction of the liquid crystal molecules located in the same plane. Here, the alignment direction of each liquid crystal molecule LM1 corresponds to the long axis direction of the liquid crystal molecule LM1 in the X-Y plane.

When one of the cholesteric liquid crystals CL surrounded by dotted lines is particularly looked at, the cholesteric liquid crystal CL consists of a plurality of liquid crystal molecules LM1 which are helically stacked in the third direction Z while twisting. The liquid crystal molecules LM1 have a liquid crystal molecule LM11 on an end side of the cholesteric liquid crystal CL.

In the liquid crystal layer 3, the alignment directions of the cholesteric liquid crystals CL which are adjacent to each other in a first direction X are different from each other. Further, the spacial phases of the cholesteric liquid crystals CL which are adjacent to each other in the first direction X are different from each other.

The alignment directions of the liquid crystal molecules LM11 which are adjacent to each other in the first direction X are different from each other. The alignment directions of the liquid crystal molecules LM11 continuously change in the first direction X. The alignment directions of the liquid crystal molecules LM11 are described later.

The reflective surface 3R inclines with respect to an X-Y plane. Here, the reflective surface 3R corresponds to a surface in which the alignment directions of the liquid crystal molecules LM1 are uniform, or a surface (an equiphase wave surface) in which the spacial phase is uniform. Inclination angle α of the reflective surface 3R is defined as an angle between an X-Y plane or the main surface 10B of the substrate 10 shown in FIG. 1 and the equiphase wave surface of the cholesteric liquid crystals CL.

This liquid crystal layer 3 is cured in a state where the alignment directions of the liquid crystal molecules LM1 are fixed. In other words, an electric field does not control the alignment directions of the liquid crystal molecules LM1. For this reason, the liquid crystal optical element 100 does not comprise an electrode for forming an electric field in the liquid crystal layer 3.

In general, in the liquid crystal layer 3 having cholesteric liquid crystals CL, selective reflection range Δλ for the light which underwent perpendicular incidence is shown by the following formula (1) based on helical pitch P of the cholesteric liquid crystals CL, refractive anisotropy Δn of the liquid crystal layer 3 (the difference between effective refractive index na for extraordinary light and refractive index no for ordinary light) and inclination angle α.

Δλ=Δn*P*cos²α (1)

Effective refractive index na is defined by the following formula.

na=(ne²+[n(α)]²)^{1/2}/2

Here, n(α) is defined by the following formula.

n(α)=ne*no/(ne²*sin²α+no²*cos²α)^{1/2}

The specific wavelength range of selective reflection range Δλ is greater than or equal to (no*P*cos²α) and less than or equal to (na*P*cos²α).

To improve the reflectance of the reflective surfaces 3R, thickness T of the liquid crystal layer 3 should be preferably approximately several times to 10 times the helical pitch. For example, the liquid crystal layer 3 has thickness T of 2 to 5 μm.

The center wavelength Δm of selective reflection range Δλ is shown by the following formula (2) based on helical pitch P of the cholesteric liquid crystals CL and the average refractive index nav (=(ne+no)/2) of the liquid crystal layer 3.

λm=nav*P*cos²α (2)

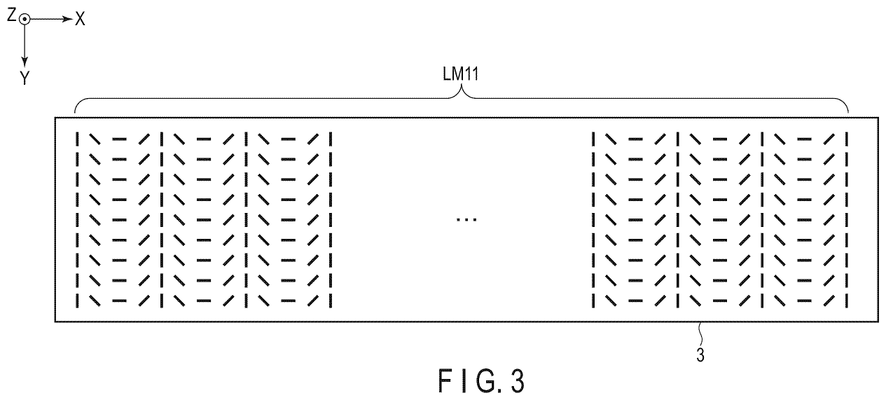

FIG. 3 is a plan view schematically showing the alignment pattern of liquid crystal molecules in the liquid crystal layer 3.

Here, the figure shows the alignment pattern of the liquid crystal molecules LM11 located on an end side of the cholesteric liquid crystals CL among the liquid crystal molecules LM1 contained in the cholesteric liquid crystals CL.

The alignment directions of the liquid crystal molecules LM11 which are arranged in the first direction X are different from each other. To the contrary, the alignment directions of the liquid crystal molecules LM11 which are arranged in a second direction Y are substantially coincident with each other.

Here, regarding the liquid crystal molecules LM11 arranged in the first direction X, the alignment direction varies with each liquid crystal molecule LM11 by a certain degree. In other words, the alignment direction linearly varies with the liquid crystal molecules LM11 arranged in the first direction X. Thus, the spacial phase linearly varies in the first direction X with the cholesteric liquid crystals CL arranged in the first direction X. As a result, the reflective surfaces 3R which incline with respect to an X-Y plane are formed as in the case of the liquid crystal layer 3 shown in FIG. 2. Here, the phrase “linearly vary” means that, for example, the amount of variation in the alignment directions of the liquid crystal molecules LM11 is shown by a linear function.

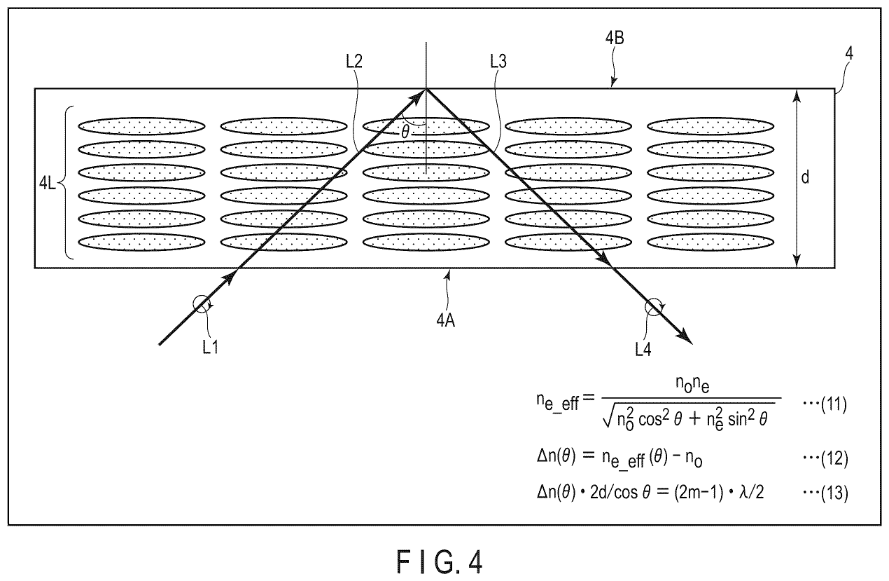

FIG. 4 is a diagram for explaining an example of the polarization control layer 4 shown in FIG. 1.

The polarization control layer 4 is a thin film having uniaxial anisotropy as described above. In the example shown in the figure, the polarization control layer 4 is a thin film including nematic liquid crystals 4L. It should be noted that the polarization control layer 4 is not limited to the example shown in the figure.

In the example shown in the figure, light L1 which enters the polarization control layer 4 through the first surface 4A is right-handed circularly polarized light. The polarization state of light L2 which travels from the first surface 4A to the second surface 4B in the polarization control layer 4 changes in accordance with the retardation of the polarization control layer 4. Light L2 is totally reflected on the second surface 4B which is in contact with the air layer, and the polarization direction is inverted. The polarization state of light L3 which travels from the second surface 4B to the first surface 4A in the polarization control layer 4 changes in accordance with the retardation of the polarization control layer 4. The polarization state of light L4 emitted from the first surface 4A is the same as that of light L1. Thus, light L4 is right-handed circularly polarized light.

In a case where light L1 which enters the polarization control layer 4 through the first surface 4A is left-handed circularly polarized light, light L4 is left-handed circularly polarized light.

A design example for realizing this polarization control is explained.

This specification assumes a case where light L1 having wavelength λ enters the polarization control layer 4 in an oblique direction. The incident angle of light L2 on the second surface 4B is defined as θ. The thickness of the polarization control layer 4 is defined as d. The refractive index of the polarization control layer 4 for extraordinary light is defined as ne. The refractive index for ordinary light is defined as no.

Effective extraordinary refractive index ne_eff is shown by formula (11) of the figure.

Refractive anisotropy Δn(θ) of the polarization control layer 4 is shown by formula (12) of the figure.

At this time, thickness d is set so as to satisfy formula (13) of the figure. In formula (13), m is an integer.

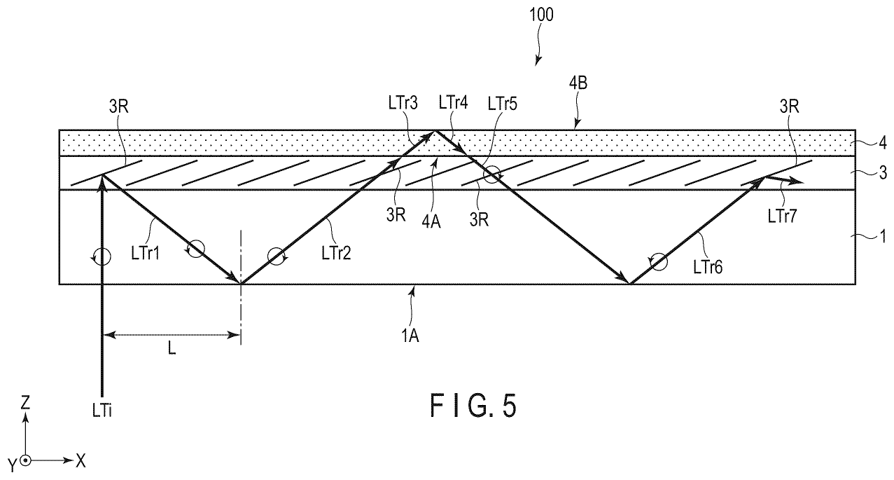

FIG. 5 is a diagram for explaining the state in which light propagates in the liquid crystal optical element 100 shown in FIG. 1. In FIG. 5, the illustration of the alignment control layer is omitted. Although not described in detail, the liquid crystal layer 3 includes, for example, cholesteric liquid crystals twisting counterclockwise, and is configured to reflect left-handed circularly polarized light (first circularly polarized light) and transmit right-handed circularly polarized light (second circularly polarized light).

Here, it is assumed that light LTi which is left-handed circularly polarized light enters the transparent substrate 1 along the normal of the transparent substrate 1. Light LTi passes through the transparent substrate 1. Subsequently, light LTi enters the liquid crystal layer 3 and is reflected on the reflective surface 3R. Light LTr1 reflected on the reflective surface 3R is left-handed circularly polarized light. Light LTr1 enters the transparent substrate 1 again and is totally reflected on the main surface 1A which is in contact with an air layer. Light LTr2 reflected on the main surface 1A is right-handed circularly polarized light. Therefore, light LTr2 passes through the reflective surface 3R of the liquid crystal layer 3 and enters the polarization control layer 4 through the first surface 4A.

As explained with reference to FIG. 4, the polarization state of the transmitted light is controlled in the polarization control layer 4. Light LTr3 which entered the polarization control layer 4 travels while the polarization state is changed, and is totally reflected on the second surface 4B which is in contact with the air layer. The reflected light LTr4 travels while the polarization state is changed, and is emitted from the first surface 4A. Light LTr5 which entered the liquid crystal layer 3 through the polarization control layer 4 is right-handed circularly polarized light. Light LTr5 passes through the reflective surface 3R of the liquid crystal layer 3, enters the transparent substrate 1 again and is totally reflected on the first main surface 1A. Light LTr6 reflected on the main surface 1A is left-handed circularly polarized light. Light LTr6 is reflected on the reflective surface 3R of the liquid crystal layer 3. Light LTr7 reflected on the reflective surface 3R is left-handed circularly polarized light. In this manner, the light which entered the liquid crystal optical element 100 propagates in the first direction X. This liquid crystal optical element 100 functions as a light guiding element for the selective reflection range.

When the distance in the first direction X between the incident position of light LTi and the position at which light LTr1 is totally reflected on the interface between the transparent substrate 1 and the air layer is defined as L, the liquid crystal optical element 100 of the embodiment can realize a propagation length greater than or equal to 2*L.

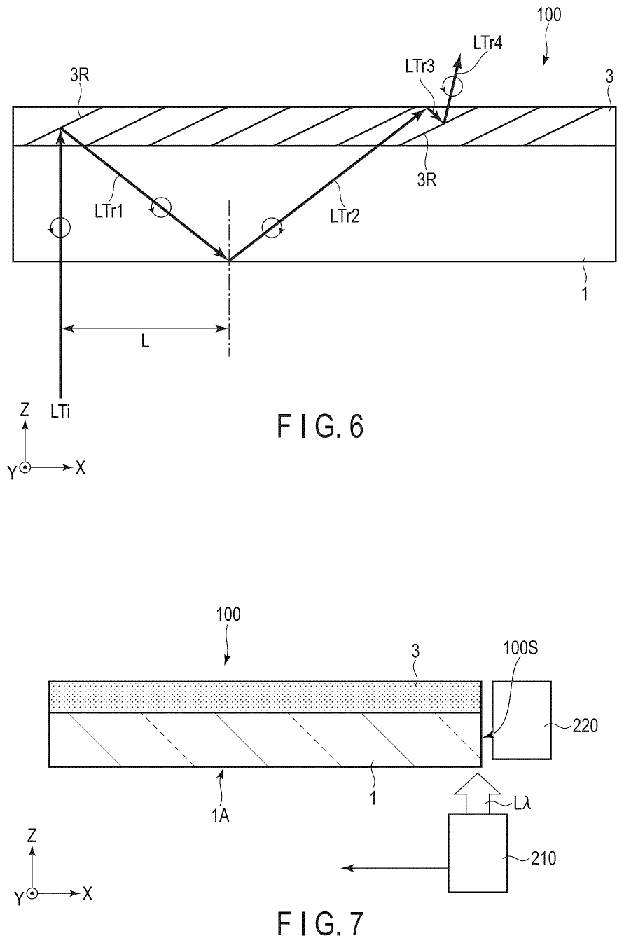

FIG. 6 is a diagram for explaining the state in which light propagates in the liquid crystal optical element 100 of a comparative example. The liquid crystal optical element 100 of the comparative example does not comprise the polarization control layer.

Light LTi which enters a transparent substrate 1 is, for example, left-handed circularly polarized light. Light LTi is reflected on the reflective surface 3R and enters the transparent substrate 1 as light LTr1 while maintaining the polarization state. Light LTr1 is totally reflected on the interface between the transparent substrate 1 and the air layer, is converted into right-handed circularly polarized light and enters the liquid crystal layer 3 again as light LTr2. Light LTr2 passes through the reflective surface 3R of the liquid crystal layer 3 and is totally reflected on the interface between the liquid crystal layer 3 and the air layer. The reflected light LTr3 is left-handed circularly polarized light. Thus, light LTr3 is reflected on the reflective surface 3R. At this time, when light LTr4 reflected on the reflective surface 3R reaches the interface between the liquid crystal layer 3 and the air layer at an incident angle which is less than the critical angle, light LTr4 leaks to the outside of the liquid crystal optical element 100. This light leakage causes a light guiding loss. Thus, in the comparative example, a light guiding loss may be generated at the position where the distance in the first direction X is approximately 2*L.

In the embodiment, the polarization control layer 4 is provided on the optical path of the light which is propagated through the liquid crystal optical element 100. In the polarization control layer 4, the polarization state of the third light beam of the light beams which enter the liquid crystal layer 3 is converted into circularly polarized light which can pass through the reflective surface 3R. This configuration prevents the leakage of light from the liquid crystal optical element 100. Thus, a light guiding loss can be prevented, and further, a long propagation length can be realized.

The inventor conducted an experiment for measuring the propagation length.

FIG. 7 is a diagram for explaining experimental conditions.

A light source 210 is provided under the liquid crystal optical element 100 and is configured to emit light Lλ having wavelength λ toward the main surface 1A of the transparent substrate 1. A detector 220 is provided so as to face a side surface 100S of the liquid crystal optical element 100.

In the experiment, the light intensity was measured by the detector 220 while the light source 210 was moved in the first direction X. In this experiment, wavelength λ of light Lλ emitted from the light source 210 was set so as to be 860 nm.

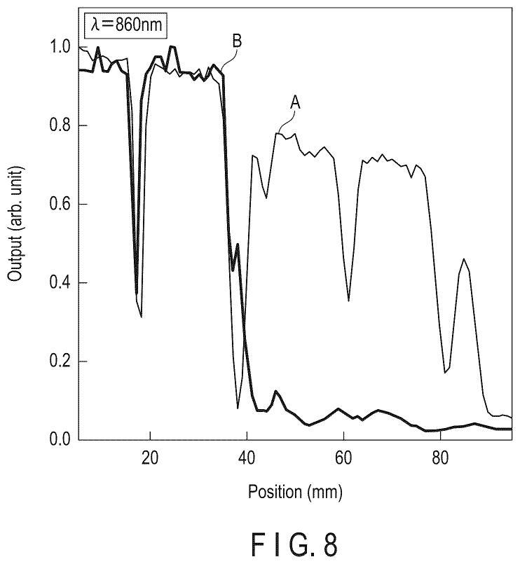

FIG. 8 is a diagram showing experimental results.

In the figure, the horizontal axis indicates the position of the light source 210 in the first direction X. The position immediately under the side surface 100S is assumed to be 0 mm.

In the figure, the vertical axis indicates the light intensity measured by the detector 220. Here, relative values which are obtained when the maximum light intensity is 1 are shown.

In the figure, A indicates the measurement result of the liquid crystal optical element 100 comprising the polarization control layer 4 shown in FIG. 5 etc., (embodiment).

In the figure, B indicates the measurement result of the liquid crystal optical element 100 which does not comprise the polarization control layer and which is shown in FIG. 6 (comparative example).

As shown in the figure, in the comparative example, the light intensity is less than or equal to 10% at the position of approximately 40 mm from the side surface 100S. To the contrary, in the embodiment, the light intensity is greater than or equal to 40% even when the position exceeds approximately 80 mm. It was confirmed that the embodiment can realize a propagation length which is longer than that of the comparative example.

Now, this specification explains another configuration example of the embodiment.

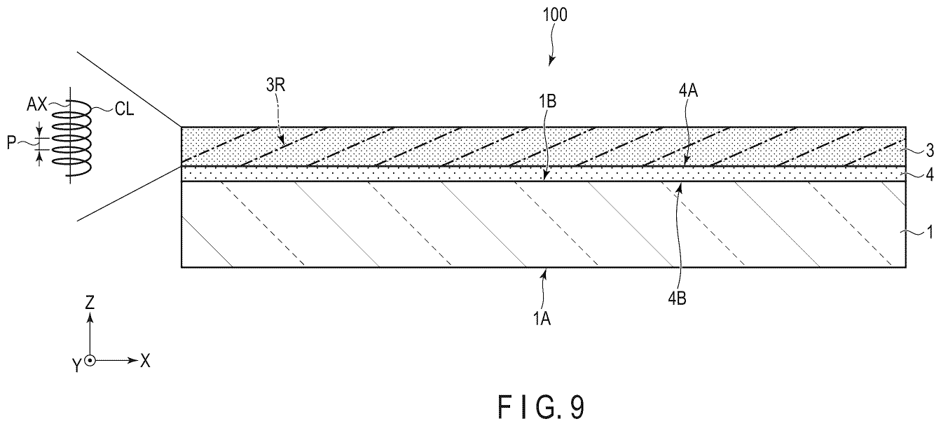

FIG. 9 is a cross-sectional view schematically showing another configuration example of the liquid crystal optical element 100.

The liquid crystal optical element 100 comprises the transparent substrate 1, the liquid crystal layer 3 and the polarization control layer 4. The configuration example shown in FIG. 9 is different from that shown in FIG. 1 in respect that the polarization control layer 4 is provided between the transparent substrate 1 and the liquid crystal layer 3. Although not shown in FIG. 9, the alignment control layer may be provided between the polarization control layer 4 and the liquid crystal layer 3.

The transparent substrate 1 has the main surface 1A and the main surface 1B.

The liquid crystal layer 3 is provided above the transparent substrate 1 in the third direction Z. The liquid crystal layer 3 includes a cholesteric liquid crystal CL as schematically shown in the enlarged view. The liquid crystal layer 3 has the reflective surfaces 3R which incline with respect to the main surface 1B. The liquid crystal layer 3 is configured to reflect circularly polarized light having the same direction as the twist direction of the cholesteric liquid crystal CL on the reflective surfaces 3R and transmit circularly polarized light having a direction opposite to the twist direction.

The polarization control layer 4 is provided on the transparent substrate 1. The polarization control layer 4 is a thin film having uniaxial anisotropy and is configured to control the polarization state of transmitted light. The polarization control layer 4 has the first surface 4A which faces the liquid crystal layer 3 in the third direction Z, and the second surface 4B which faces the transparent substrate on a side opposite to the first surface 4A. In the example shown in the figure, the first surface 4A is in contact with the liquid crystal layer, and the second surface 4B is in contact with the transparent substrate 1.

The polarization control layer 4 is configured to twice transmit the left-handed circularly polarized light reflected on the reflective surface 3R of the liquid crystal layer 3 and emit the light to the liquid crystal layer 3 as left-handed circularly polarized light, or twice transmit the right-handed circularly polarized light reflected on the reflective surface 3R of the liquid crystal layer 3 and emit the light to the liquid crystal layer 3 as right-handed circularly polarized light. The details of the polarization control layer 4 are described later.

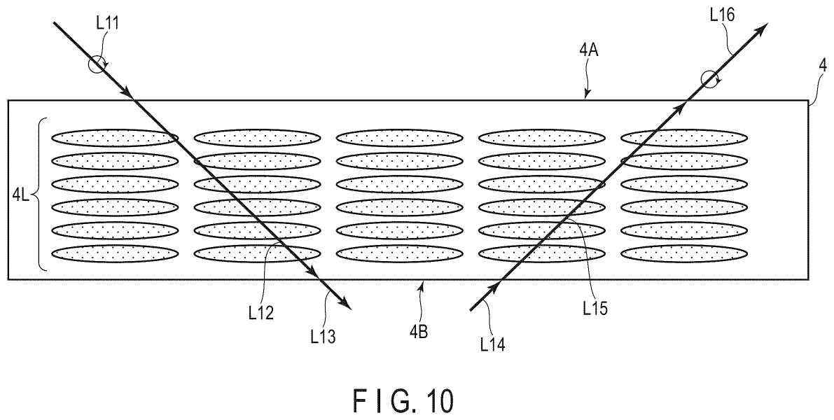

FIG. 10 is a diagram for explaining an example of the polarization control layer 4 shown in FIG. 9.

The polarization control layer 4 is a thin film having uniaxial anisotropy as described above. In the example shown in the figure, the polarization control layer 4 is a thin film including nematic liquid crystals 4L. It should be noted that the polarization control layer 4 is not limited to the example shown in the figure.

In the example shown in the figure, light L11 which enters the polarization control layer 4 through the first surface 4A is right-handed circularly polarized light. The polarization state of light L12 which travels from the first surface 4A to the second surface 4B in the polarization control layer 4 changes in accordance with the retardation of the polarization control layer 4. Light L13 is emitted from the second surface 4B. Subsequently, light L14 enters the polarization control layer 4 again through the second surface 4B. The polarization state of light L15 which travels from the second surface 4B to the first surface 4A in the polarization control layer 4 changes in accordance with the retardation of the polarization control layer 4. Light L16 is emitted from the first surface 4A. The polarization state of light L16 is the same as that of light L11. Thus, light L16 is right-handed circularly polarized light.

In a case where light L11 which enters the polarization control layer 4 through the first surface 4A is left-handed circularly polarized light, light L16 is left-handed circularly polarized light.

In a case where the light which enters the polarization control layer 4 through the second surface 4B is right-handed circularly polarized light, the light passes through the polarization control layer 4 twice, and is subsequently emitted as right-handed circularly polarized light. Similarly, in a case where the light which enters the polarization control layer 4 through the second surface 4B is left-handed circularly polarized light, the light passes through the polarization control layer 4 twice, and is subsequently emitted as left-handed circularly polarized light.

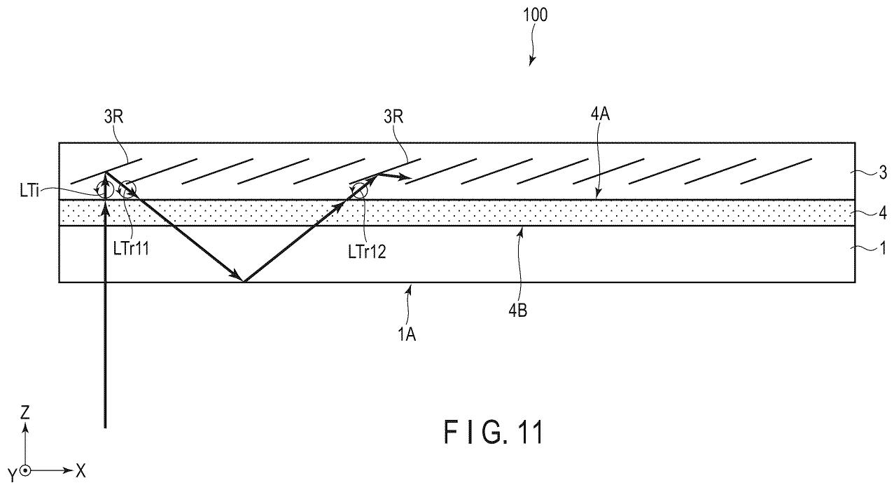

FIG. 11 is a diagram for explaining the state in which light propagates in the liquid crystal optical element 100 shown in FIG. 9. Although not described in detail, the liquid crystal layer 3 has, for example, cholesteric liquid crystals twisting counterclockwise, and is configured to reflect left-handed circularly polarized light (first circularly polarized light) and transmit right-handed circularly polarized light (second circularly polarized light).

Light LTi which passed through the transparent substrate 1 and the polarization control layer 4 after the incidence along the normal of the transparent substrate 1 is left-handed circularly polarized light. Light LTi enters the liquid crystal layer 3 and is reflected on the reflective surface 3R. Light LTr11 reflected on the reflective surface 3R is left-handed circularly polarized light. Light LTr11 passes through the polarization control layer 4, subsequently enters the transparent substrate 1, is totally reflected on the first surface 1A which is in contact with the air layer, and passes through the polarization control layer 4 again. Light LTr12 which enters the liquid crystal layer 3 is left-handed circularly polarized light. Therefore, light LTr12 is reflected on the reflective surface 3R of the liquid crystal layer 3. In this manner, the light which entered the liquid crystal optical element 100 is propagated in the first direction X.

In this configuration example, effects similar to those of the configuration example described above are obtained.

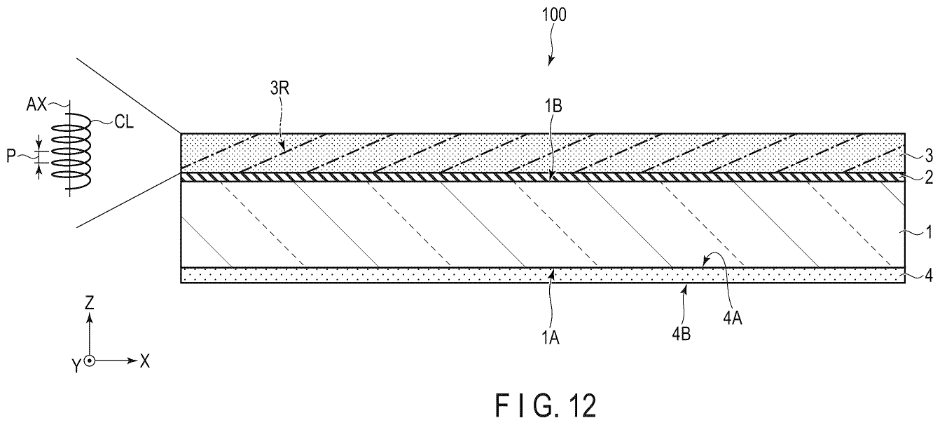

FIG. 12 is a cross-sectional view schematically showing another configuration example of the liquid crystal optical element 100.

The liquid crystal optical element 100 comprises the transparent substrate 1, the alignment control layer 2, the liquid crystal layer 3 and the polarization control layer 4. The configuration example shown in FIG. 12 is different from that shown in FIG. 1 in respect that the polarization control layer 4 is provided on the main surface 1A of the transparent substrate 1. It should be noted that the alignment control layer 2 shown in FIG. 12 may be omitted.

The transparent substrate 1 has the main surface 1A and the main surface 1B.

The liquid crystal layer 3 is provided on the transparent substrate 1 or the alignment control layer 2 in the third direction Z. The liquid crystal layer 3 has a cholesteric liquid crystal CL as schematically shown in the enlarged view. The liquid crystal layer 3 has the reflective surfaces 3R which incline with respect to the main surface 1B. The liquid crystal layer 3 is configured to reflect circularly polarized light having the same direction as the twist direction of the cholesteric liquid crystal CL on the reflective surfaces 3R and transmit circularly polarized light having a direction opposite to the twist direction.

The polarization control layer 4 is provided on the main surface 1A of the transparent substrate 1. The polarization control layer 4 is a thin film having uniaxial anisotropy and is configured to control the polarization state of transmitted light. The polarization control layer 4 has the first surface 4A which faces the transparent substrate 1 in the third direction Z, and the second surface 4B on a side opposite to the first surface 4A. In the example shown in the figure, the first surface 4A is in contact with the transparent substrate 1, and the second surface 4B is in contact with the air layer.

The polarization control layer 4 is configured to totally reflect the left-handed circularly polarized light reflected on the reflective surface 3R of the liquid crystal layer 3 and emit the light to the liquid crystal layer 3 as left-handed circularly polarized light, or totally reflect the right-handed circularly polarized light reflected on the reflective surface 3R of the liquid crystal layer 3 and emit the light to the liquid crystal layer 3 as right-handed circularly polarized light.

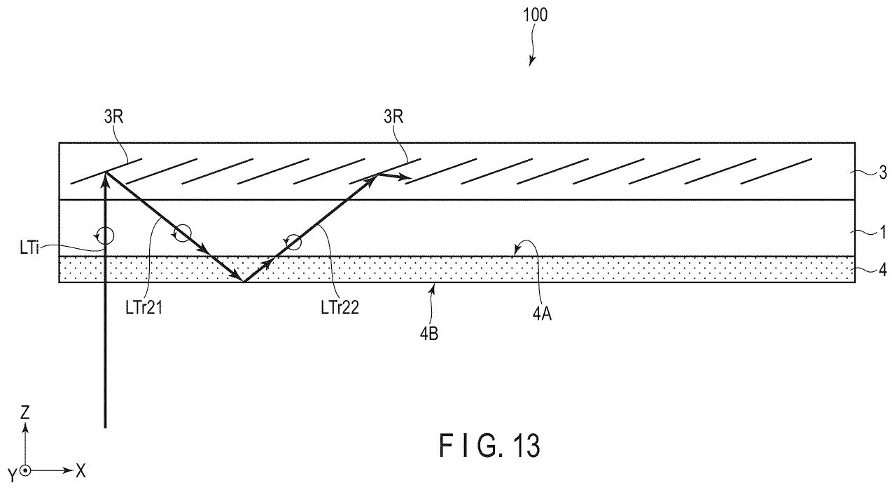

FIG. 13 is a diagram for explaining the state in which light propagates in the liquid crystal optical element 100 shown in FIG. 12. In FIG. 13, the illustration of the alignment control layer is omitted. Although not described in detail, the liquid crystal layer 3 has, for example, cholesteric liquid crystals twisting counterclockwise, and is configured to reflect left-handed circularly polarized light (first circularly polarized light) and transmit right-handed circularly polarized light (second circularly polarized light).

Light LTi which passed through the polarization control layer 4 is left-handed circularly polarized light and enters the transparent substrate 1 along the normal of the transparent substrate 1. Light LTi enters the liquid crystal layer 3 and is reflected on the reflective surface 3R. Light LTr21 reflected on the reflective surface 3R is left-handed circularly polarized light. Light LTr21 enters the polarization control layer 4 after passing through the transparent substrate 1, and is totally reflected on the second surface 4B which is in contact with the air layer. Light LTr22 which is emitted from the polarization control layer 4 to the transparent substrate 1 is left-handed circularly polarized light. Therefore, light LTr22 is reflected on the reflective surface 3R of the liquid crystal layer 3 after passing through the transparent substrate 1. In this manner, the light which entered the liquid crystal optical element 100 is propagated in the first direction X.

In this configuration example, effects similar to those of the configuration example described above are obtained.

As explained above, the embodiment can provide a liquid crystal optical element in which a light guiding loss can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal optical element comprising:
a transparent substrate;
a liquid crystal layer provided above the transparent substrate, including a cholesteric liquid crystal, and configured to reflect first circularly polarized light having a same direction as a twist direction of the cholesteric liquid crystal; and
a polarization control layer provided on the liquid crystal layer, and configured to control a polarization state of second circularly polarized light having a direction opposite to the first circularly polarized light, totally reflect the second circularly polarized light which passed through the liquid crystal layer and emit the light to the liquid crystal layer as the second circularly polarized light.

2. The liquid crystal optical element of claim 1, wherein
the polarization control layer has a first surface which faces the liquid crystal layer, and a second surface on a side opposite to the first surface, and
the second surface is in contact with a low-refractive layer having a refractive index which is lower than the polarization control layer.

3. A liquid crystal optical element comprising:
a transparent substrate;
a liquid crystal layer including a cholesteric liquid crystal, and configured to reflect first circularly polarized having a same direction as a twist direction of the cholesteric liquid crystal and transmit second circularly polarized light having a direction opposite to the first circularly polarized light; and
a polarization control layer provided between the transparent substrate and the liquid crystal layer, wherein
the polarization control layer is configured to twice transmit the first circularly polarized light reflected on the liquid crystal layer and emit the light to the liquid crystal layer as the first circularly polarized light.

4. The liquid crystal optical element of claim 3, wherein
the polarization control layer has a first surface which faces the liquid crystal layer, and a second surface which faces the transparent substrate on a side opposite to the first surface.

5. The liquid crystal optical element of claim 1, wherein
the polarization control layer is a thin film having uniaxial anisotropy.

6. The liquid crystal optical element of claim 3, wherein
the polarization control layer is a thin film having uniaxial anisotropy.

7. The liquid crystal optical element of claim 1, wherein
the polarization control layer is a thin film including a nematic liquid crystal.

8. The liquid crystal optical element of claim 3, wherein
the polarization control layer is a thin film including a nematic liquid crystal.

9. The liquid crystal optical element of claim 1, wherein
the liquid crystal layer has a thickness of 2 to 5 μm.

10. The liquid crystal optical element of claim 3, wherein
the liquid crystal layer has a thickness of 2 to 5 μm.

11. The liquid crystal optical element of claim 1, wherein
the polarization control layer has a thickness which is equal to the liquid crystal layer or a thickness which is less than a thickness of the liquid crystal layer.

12. The liquid crystal optical element of claim 3, wherein
the polarization control layer has a thickness which is equal to the liquid crystal layer or a thickness which is less than a thickness of the liquid crystal layer.
